(19) United States
(12) Patent Application Publication
(10) Pub. No.: US 2009/0220319 A1
(43) Pub. Date: Sep. 3, 2009

(54) Captive fasteners for bicycle chainguides

(76) Inventor: David Weagle, Edgartown, MA (US)

Correspondence Address: STAHL LAW FIRM, 2 MEADOWSWEET LANE, SAN CARLOS, CA, 94070, US

(21) Appl. No.: 12/072,905

(22) Filed: Feb. 28, 2008

(51) Int. Cl. F16B 37/04; F16H 55/12; F16B 23/00

(52) U.S. Cl. 411/103; 474/160; 411/403

(57) ABSTRACT

The present invention according to certain embodiments relates to chain guides with captive fasteners. A chain guide of the current invention in certain embodiments is designed to preserve resources through use of stamped parts. A chain guide of the current invention in certain embodiments is designed to preserve resources by facilitating its assembly onto a bicycle in a less labor-intensive manner.

### 1.0 FIELD OF THE INVENTION

The current invention relates to captive fasteners for bicycle chainguides. Captive fasteners of the invention are useful to reduce assembly cost of and simplify adjustment of guide elements of a bicycle chainguide.

### 2.0 BACKGROUND

Mountain biking is a popular recreational pastime. Mountain biking typically happens on off-road trails and rough surfaces. A typical mountain bike uses a foot operated crank assembly to transfer a rider's motion through a sprocket, to a chain, and through another sprocket attached to a wheel to drive the bicycle forward. Some of the disciplines in mountain biking include cross country riding, all-mountain riding, freeriding, and downhill riding, with cross country riding taking place on trails with the smallest bumps and lowest speeds, and downhill riding taking place on trails with the largest bumps and highest speeds. Some disciplines of mountain biking include competitions where rider's compete for prizes and or money. Larger bumps traversed in the typical off-road trail can be more easily traversed by a mountain bike that comprises a suspended rear wheel that can absorb impacts when a rear wheel hits a bump, and specialized drivetrain components that can help to stop the drive chain from skipping off of sprockets. Bicycle chainguides are an important part of a mountain bike drivetrain, especially where larger bumps and higher speeds are common. A bicycle chainguide is a bicycle component that is designed to hold a chain on a chainring when the chain is bouncing due to a mountain bike traversing rough terrain.

Mountain bikes have become increasingly popular in recent years. Previously, mountain bikes with a suspended rear wheel were very costly to obtain. Materials used to build a suspended rear wheel mountain bike were costly, and manufacturers who had the capability to manufacture such bicycles charged high rates for their services. Downhill type bicycles typically use the longest travel suspension, and are typically the most complex designs available. Light weight is a very important consideration for any mountain bike, and because of this light weight requirement, key components of the chainguides were manufactured from costly and lightweight materials such as aluminum, and key elements of the chainguides themselves built using low production volume and high cost manufacturing techniques such as CNC machining.

Because many downhill type models are used for competitive racing, and because of the complex designs used in these models, maintenance service for these bikes is more frequent than other types of bicycles. A typical downhill bicycle will be cleaned, adjusted, and maintained for one hour for every three hours of riding. Many types of and high quantities of fasteners are used to assemble a downhill bicycle frame and to assemble the components that attach to the bicycle frame. Ease of assembly, disassembly, and maintenance is a desirable trait of any downhill type bicycle design.

The complex designs found on downhill type bicycles often includes frame configurations that are not found in other types of bicycles. These designs can include large diameter tubular structures welded to forged parts. These large tubes and other structural parts can make it difficult to access to the fasteners that assemble bicycle components like a bicycle chainguide.

Many bicycles sold today are sold as complete bicycles, meaning that the complete bicycle includes a frame and all components pre-assembled by a factory and sold as a unit. A bicycle frame and the components that are assembled on that frame by an assembly factory are sourced from different companies all over the world. A frame assembly factory typically uses manual labor on an assembly line to assemble bicycle components and then to assemble the components onto a frame. Assembly time is a factor in the cost of a bicycle, so the lower the time to assemble a component or complete bicycle, the lower the overall cost of the complete bicycle. Chainguide components designed for ease of assembly have been in the past built from billet aluminum alloys using low production volume and high cost manufacturing techniques such as CNC machining. Chainguide assemblies using stamped steel backplates have been built, but because of the limitations of the stamping process, these lower cost alternatives have not used any type of captive fastener, thus requiring the use of a tool to hold a fastener on the back side of a mounting plate, while another fastener is turned or installed from the front side of the mounting plate. In addition to the extra assembly time that using multiple tools adds, the difficult access to fasteners on many downhill type molds forces even more complex and time consuming assembly operations. This complex assembly and adjustment for a chainguide adds assembly time and cost to a complete bicycle.

There is a need for bicycle chainguide designs that are less costly to manufacture, and offer ease of assembly, adjustment, maintenance, and access to fasteners used to assemble bicycle chainguides and complete bicycles. The present invention provides chainguides and captive fasteners for bicycle chainguides that satisfy one or more of these needs.

### 3.0 SUMMARY OF THE INVENTION

The current invention relates to chainguides and captive fasteners for chainguides. A chainguide of the invention, in certain embodiments comprises a mounting plate, a guide element, fasteners used to assemble the chainguide, and/or mechanical elements used to hold fasteners captive during chainguide and complete bike assembly. A chainguide of the invention, in certain embodiments, is designed to fix a guide element in relation to a chain and a sprocket so that the chain's rollers are guided to engage or disengage with the teeth of a sprocket. A chainguide of the invention, in certain embodiments can comprise one or more of the following: a guide element at the point where a chain engages with a sprocket, a guide element at the point where a chain disengages with a sprocket, a guide element or elements for a single sprocket, a guide element for multiple sprockets. A guide element of the current invention in certain embodiments is fixed in relation to a chain and a sprocket via a mounting plate. A guide element of the current invention in certain embodiments is attached to a mounting plate so as to allow adjustment of the guide element in at least one degree of freedom in relation to the mounting plate. A guide element of the current invention in certain embodiments is attached to a mounting plate using a combination of fasteners. A chainguide of the invention, in certain embodiments, is designed to save manufacturing costs. A chainguide of the invention in certain embodiments uses a stamped, molded, and/or formed mounting plate to help reduce cost. In certain preferred embodiments, a mounting plate of a chainguide of the invention is manufactured from stamped steel alloy sheet, where mechanical elements used to hold fasteners captive during chainguide and complete bike assembly are stamped into the mounting plate. A mounting plate of a chainguide of the invention is not manufactured from aluminum alloy with a percentage of aluminum in the aluminum alloy greater than 60%, and where CNC machining is used to create mechanical elements used to hold fasteners captive during chainguide and complete bike assembly. In certain embodiments, a chainguide of the invention uses a captive fastener that keys or is otherwise held by a combination of features of the fastener and a mounting plate so as to impede the rotation of the captive fastener, and to allow for simplified and expedient assembly of a chainguide.

### 4.0 BRIEF DESCRIPTION OF THE DRAWINGS

FIG. 1A illustrates a back view of a chainguide and captive fastener arrangement.

FIG. 1B illustrates a close up sectional view A-A as defined by FIG. 1A of the present invention.

FIG. 1C illustrates a three-dimensional view of the chainguide and captive fastener arrangement shown in FIGS. 1A and 1B.

FIG. 2A illustrates a back view of a chainguide and captive fastener arrangement.

FIG. 2B illustrates a close up sectional view A-A as defined by FIG. 2A of the present invention.

FIG. 2C illustrates a three-dimensional view of the chainguide and captive fastener arrangement shown in FIGS. 2A and 2B.

FIG. 3A illustrates a back view of a chainguide and captive fastener arrangement.

FIG. 3B illustrates a close up sectional view A-A as defined by FIG. 3A of the present invention.

FIG. 3C illustrates a three-dimensional view of the chainguide and captive fastener arrangement shown in FIGS. 3A and 3B.

### 5.0 DETAILED DESCRIPTION

The current invention relates to chainguides and captive fasteners for chainguides. A chainguide of the invention, in certain embodiments comprises a mounting plate, a guide element, fasteners used to assemble the chainguide, and mechanical elements used to hold fasteners captive during chainguide and complete bike assembly. A chainguide of the invention, in certain embodiments, is designed to fix a guide element in relation to a chain and a sprocket so that the chain's rollers are guided to engage or disengage with the teeth of a sprocket. A chainguide of the invention, in certain embodiments can comprise one or more of the following: a guide element at the point where a chain engages with a sprocket, a guide element at the point where a chain disengages with a sprocket, a guide element or elements for a single sprocket, a guide element for multiple sprockets. A guide element of the current invention in certain embodiments is fixed in relation to a chain and a sprocket via a mounting plate. A guide element of the current invention in certain embodiments is attached to a mounting plate so as to allow adjustment of the guide element in at least one degree of freedom in relation to the mounting plate. A guide element of the current invention in certain embodiments is attached to a mounting plate using a combination of fasteners. A chainguide of the invention, in certain embodiments, is designed to save manufacturing costs. A chainguide of the invention in certain embodiments uses a stamped, molded, and/or formed mounting plate to help reduce cost. In certain preferred embodiments, a mounting plate of a chainguide of the invention is manufactured from stamped steel alloy sheet, where mechanical elements used to hold fasteners captive during chainguide and complete bike assembly are stamped into the mounting plate. A mounting plate of a chainguide of the invention is not manufactured from aluminum alloy with a percentage of aluminum in the aluminum alloy greater than 60%, and where CNC machining is used to create mechanical elements used to hold fasteners captive during chainguide and complete bike assembly. In certain embodiments, a chainguide of the invention uses a captive fastener that keys or is otherwise held by a combination of features of the fastener and a mounting plate so as to impede the rotation of the captive fastener, and to allow for simplified and expedient assembly of a chainguide.

### 5.1 THE DRAWINGS ILLUSTRATE EXAMPLES OF CERTAIN EMBODIMENTS OF THE INVENTION

The Figures in this disclosure use the following numbers and terms: mounting plate (1); inner fastener (2); captive fastener feature (3); outer fastener (4); guide element (5); multi fastener (6); tab fastener (7). The singular of a term used herein is meant to include the plural and vice versa, unless the opposite is indicated or apparent from the context.

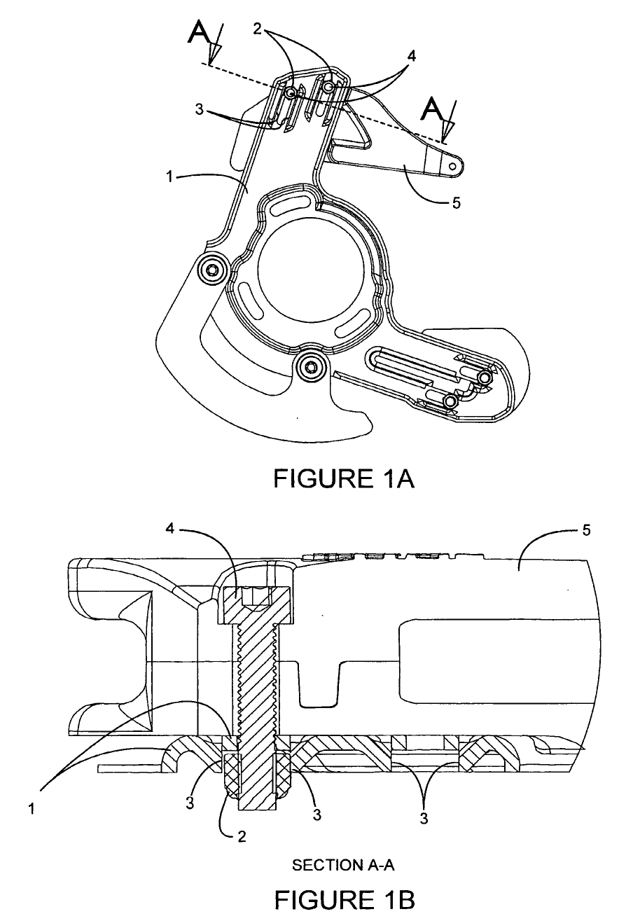

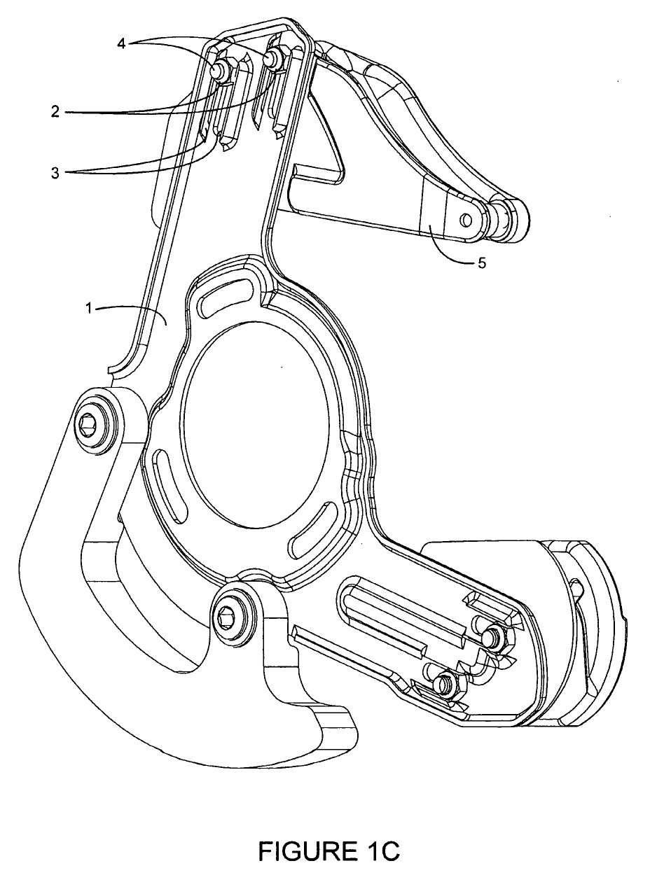

FIG. 1A presents a design for a chainguide according to certain embodiments of the current invention via a back view. Shown in FIG. 1A are the following: mounting plate (1); inner fastener (2); captive fastener feature (3); outer fastener (4); guide element (5). A mounting plate 1 supports an inner fastener 2 in at least two degrees of freedom. Material in the mounting plate 1 impedes the inner fastener 2 from passing through the mounting plate 1, while an outer fastener 4 and inner fastener 2 attach a guide element 5 to the mounting plate. The inner fastener 2 and outer fastener 4 are threaded so that when the inner fastener 2 and outer fastener 4 are turned in opposite directions, the inner fastener 2 and outer fastener 4 move towards each other. A clamping force between the inner fastener 2 and outer fastener 4 is developed due to the inner fastener 2 and outer fastener 4 moving towards each other as they are turned in opposite directions. The inner fastener 2 has two or more edges that can be held with a tool or mounting plate 1 feature to impede the rotation of the inner fastener 2, and therefore facilitate the assembly of the outer fastener 4 and inner fastener 2. A captive fastener feature 3 is manufactured as part of the mounting plate 1. The captive fastener feature 3 is designed so that the captive fastener feature 3 has two faces or edges that are in close contact to the previously mentioned faces intended to be held with a tool on the inner fastener 2. The captive fastener feature 3 is designed such that an inner fastener 2 that is placed in the captive fastener feature 3 is unable to rotate because faces or edges of the captive fastener feature 3 meet faces of the inner fastener 2, impeding rotation of the inner fastener 2 due to interference with the captive fastener feature 3 when the inner fastener 2 begins to rotate. Installation is facilitated by turning the outer fastener 4 while the inner fastener 2 is held from rotating by the captive fastener feature 3. Because the inner fastener 2 and captive fastener feature 3 interlock and prevent rotation of the inner fastener 2, a secondary tool is not needed to hold the inner fastener 2 during assembly of the chainguide. This has the added benefit of not requiring an assembly technician to try to fit a tool between a bicycle frame and a mounting plate 1 in situations where room to do so may not exist.

FIG. 1B presents a design for a chainguide according to certain embodiments of the current invention via a close up sectional view A-A. Shown in FIG. 1B are the following: mounting plate (1); inner fastener (2); captive fastener feature (3); outer fastener (4); guide element (5). A mounting plate 1 supports an inner fastener 2 in at least two degrees of freedom. Material in the mounting plate 1 impedes the inner fastener 2 from passing through the mounting plate 1, while an outer fastener 4 and inner fastener 2 attach a guide element 5 to the mounting plate. The inner fastener 2 and outer fastener 4 are threaded so that when the inner fastener 2 and outer fastener 4 are turned in opposite directions, the inner fastener 2 and outer fastener 4 move towards each other. A clamping force between the inner fastener 2 and outer fastener 4 is developed due to the inner fastener 2 and outer fastener 4 moving towards each other as they are turned in opposite directions. The inner fastener 2 has two or more edges that can be held with a tool or mounting plate 1 feature to impede the rotation of the inner fastener 2, and therefore facilitate the assembly of the outer fastener 4 and inner fastener 2. A captive fastener feature 3 is manufactured as part of the mounting plate 1. The captive fastener feature 3 is designed so that the captive fastener feature 3 has two faces or edges that are in close contact to the previously mentioned faces intended to be held with a tool on the inner fastener 2. The captive fastener feature 3 is designed such that an inner fastener 2 that is placed in the captive fastener feature 3 is unable to rotate because faces or edges of the captive fastener feature 3 meet faces of the inner fastener 2, impeding rotation of the inner fastener 2 due to interference with the captive fastener feature 3 when the inner fastener 2 begins to rotate. Installation is facilitated by turning the outer fastener 4 while the inner fastener 2 is held from rotating by the captive fastener feature 3. Because the inner fastener 2 and captive fastener feature 3 interlock and prevent rotation of the inner fastener 2, a secondary tool is not needed to hold the inner fastener 2 during assembly of the chainguide. This has the added benefit of not requiring an assembly technician to try to fit a tool between a bicycle frame and a mounting plate 1 in situations where room to do so may not exist.

FIG. 1C presents a design for a chainguide according to certain embodiments of the current invention via a 3 dimensional back view. Shown in FIG. 1C are the following: mounting plate (1); inner fastener (2); captive fastener feature (3); outer fastener (4); guide element (5). A mounting plate 1 supports an inner fastener 2 in at least two degrees of freedom. Material in the mounting plate 1 impedes the inner fastener 2 from passing through the mounting plate 1, while an outer fastener 4 and inner fastener 2 attach a guide element 5 to the mounting plate. The inner fastener 2 and outer fastener 4 are threaded so that when the inner fastener 2 and outer fastener 4 are turned in opposite directions, the inner fastener 2 and outer fastener 4 move towards each other. A clamping force between the inner fastener 2 and outer fastener 4 is developed due to the inner fastener 2 and outer fastener 4 moving towards each other as they are turned in opposite directions. The inner fastener 2 has two or more edges that can be held with a tool or mounting plate 1 feature to impede the rotation of the inner fastener 2, and therefore facilitate the assembly of the outer fastener 4 and inner fastener 2. A captive fastener feature 3 is manufactured as part of the mounting plate 1. The captive fastener feature 3 is designed so that the captive fastener feature 3 has two faces or edges that are in close contact to the previously mentioned faces intended to be held with a tool on the inner fastener 2. The captive fastener feature 3 is designed such that an inner fastener 2 that is placed in the captive fastener feature 3 is unable to rotate because faces or edges of the captive fastener feature 3 meet faces of the inner fastener 2, impeding rotation of the inner fastener 2 due to interference with the captive fastener feature 3 when the inner fastener 2 begins to rotate. Installation is facilitated by turning the outer fastener 4 while the inner fastener 2 is held from rotating by the captive fastener feature 3. Because the inner fastener 2 and captive fastener feature 3 interlock and prevent rotation of the inner fastener 2, a secondary tool is not needed to hold the inner fastener 2 during assembly of the chainguide. This has the added benefit of not requiring an assembly technician to try to fit a tool between a bicycle frame and a mounting plate 1 in situations where room to do so may not exist.

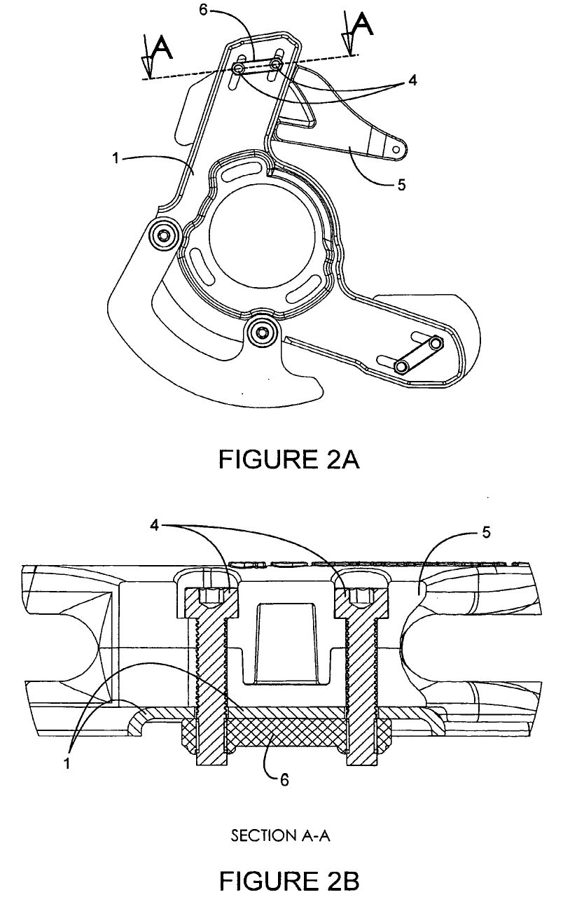

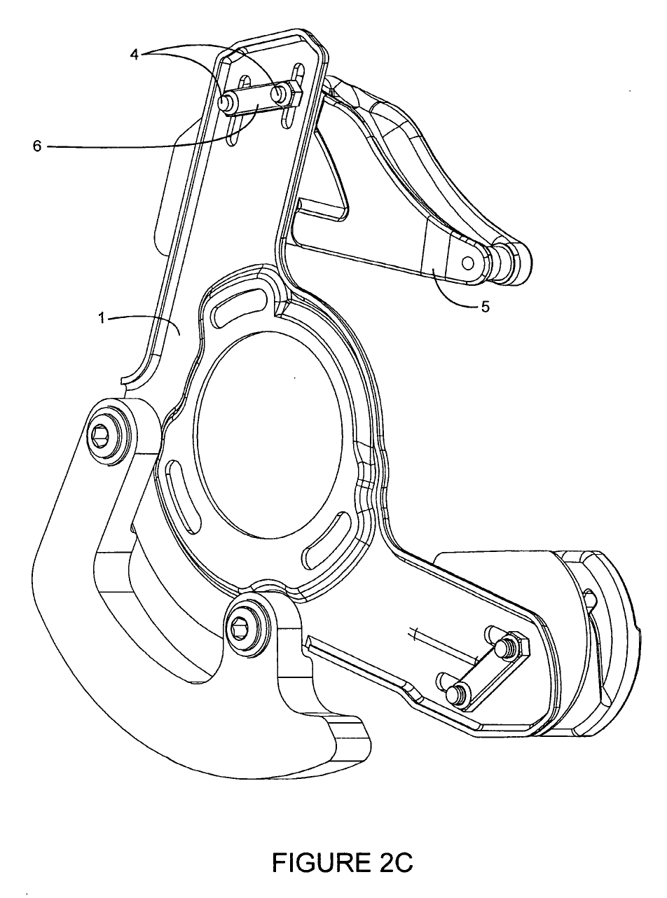

FIG. 2A presents a design for a chainguide according to certain embodiments of the current invention via a back view. Shown in FIG. 2A are the following: mounting plate (1); outer fastener (4); guide element (5); multi fastener (6). A mounting plate 1 supports a multi fastener 6 in at least one degree of freedom. Material in the mounting plate 1 impedes the multi fastener 6 from passing through the mounting plate 1, while an outer fastener 4 and multi fastener 6 attach a guide element 5 to the mounting plate. The multi fastener 6 and outer fastener 4 are threaded so that when the multi fastener 6 and outer fastener 4 are turned in opposite directions, the multi fastener 6 and outer fastener 4 move towards each other. A clamping force between the multi fastener 6 and outer fastener 4 is developed due to the multi fastener 6 and outer fastener 4 moving towards each other as they are turned in opposite directions. The multi fastener 6 shown in this embodiment has threaded holes for accepting two outer fasteners 4. When multiple outer fasteners 4 are engaged with the mounting plate 1, and multi fastener 6, the outer fasteners 4 interfere with the mounting plate 1, and through this interference, the rotation of the multi fastener 6 is impeded. This therefore facilitates the assembly of the outer fastener 4 and multi fastener 6. Because the multi fastener 6, outer fasteners 4, and mounting plate 1 interlock in a manner that prevents rotation of the multi fastener 6, a secondary tool is not needed to hold the inner fastener during assembly of the chainguide. This has the added benefit of not requiring an assembly technician to try to fit a tool between a bicycle frame and a mounting plate 1 in situations where room to do so may not exist.

FIG. 2B presents a design for a chainguide according to certain embodiments of the current invention via a close up sectional view A-A. Shown in FIG. 2B are the following: mounting plate (1); outer fastener (4); guide element (5); multi fastener (6). A mounting plate 1 supports a multi fastener 6 in at least one degree of freedom. Material in the mounting plate 1 impedes the multi fastener 6 from passing through the mounting plate 1, while an outer fastener 4 and multi fastener 6 attach a guide element 5 to the mounting plate. The multi fastener 6 and outer fastener 4 are threaded so that when the multi fastener 6 and outer fastener 4 are turned in opposite directions, the multi fastener 6 and outer fastener 4 move towards each other. A clamping force between the multi fastener 6 and outer fastener 4 is developed due to the multi fastener 6 and outer fastener 4 moving towards each other as they are turned in opposite directions. The multi fastener 6 shown in this embodiment has threaded holes for accepting two outer fasteners 4. When multiple outer fasteners 4 are engaged with the mounting plate 1, and multi fastener 6, the outer fasteners 4 interfere with the mounting plate 1, and through this interference, the rotation of the multi fastener 6 is impeded. This therefore facilitates the assembly of the outer fastener 4 and multi fastener 6. Because the multi fastener 6, outer fasteners 4, and mounting plate 1 interlock in a manner that prevents rotation of the multi fastener 6, a secondary tool is not needed to hold the inner fastener during assembly of the chainguide. This has the added benefit of not requiring an assembly technician to try to fit a tool between a bicycle frame and a mounting plate 1 in situations where room to do so may not exist.

FIG. 2C presents a design for a chainguide according to certain embodiments of the current invention via a 3 dimensional back view. Shown in FIG. 2C are the following: mounting plate (1); outer fastener (4); guide element (5); multi fastener (6). A mounting plate 1 supports a multi fastener 6 in at least one degree of freedom. Material in the mounting plate 1 impedes the multi fastener 6 from passing through the mounting plate 1, while an outer fastener 4 and multi fastener 6 attach a guide element 5 to the mounting plate. The multi fastener 6 and outer fastener 4 are threaded so that when the multi fastener 6 and outer fastener 4 are turned in opposite directions, the multi fastener 6 and outer fastener 4 move towards each other. A clamping force between the multi fastener 6 and outer fastener 4 is developed due to the multi fastener 6 and outer fastener 4 moving towards each other as they are turned in opposite directions. The multi fastener 6 shown in this embodiment has threaded holes for accepting two outer fasteners 4. When multiple outer fasteners 4 are engaged with the mounting plate 1, and multi fastener 6, the outer fasteners 4 interfere with the mounting plate 1, and through this interference, the rotation of the multi fastener 6 is impeded. This therefore facilitates the assembly of the outer fastener 4 and multi fastener 6. Because the multi fastener 6, outer fasteners 4, and mounting plate 1 interlock in a manner that prevents rotation of the multi fastener 6, a secondary tool is not needed to hold the inner fastener during assembly of the chainguide. This has the added benefit of not requiring an assembly technician to try to fit a tool between a bicycle frame and a mounting plate 1 in situations where room to do so may not exist.

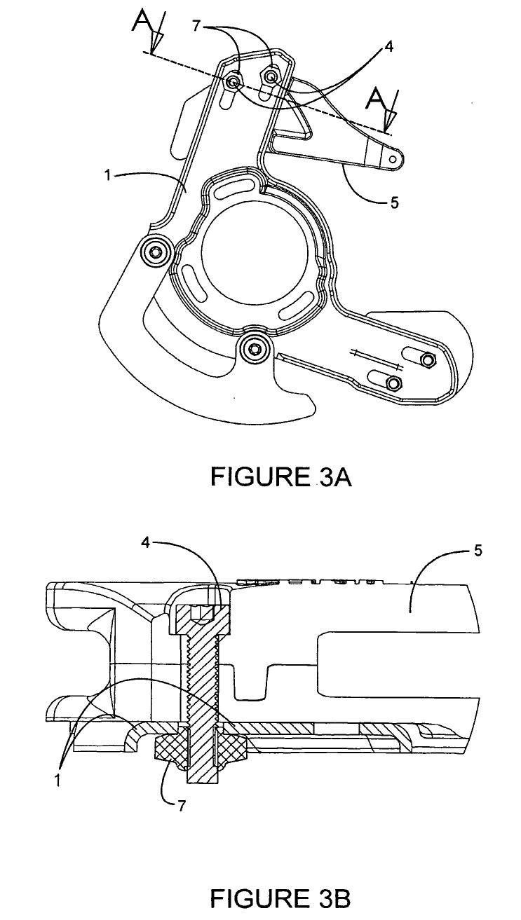

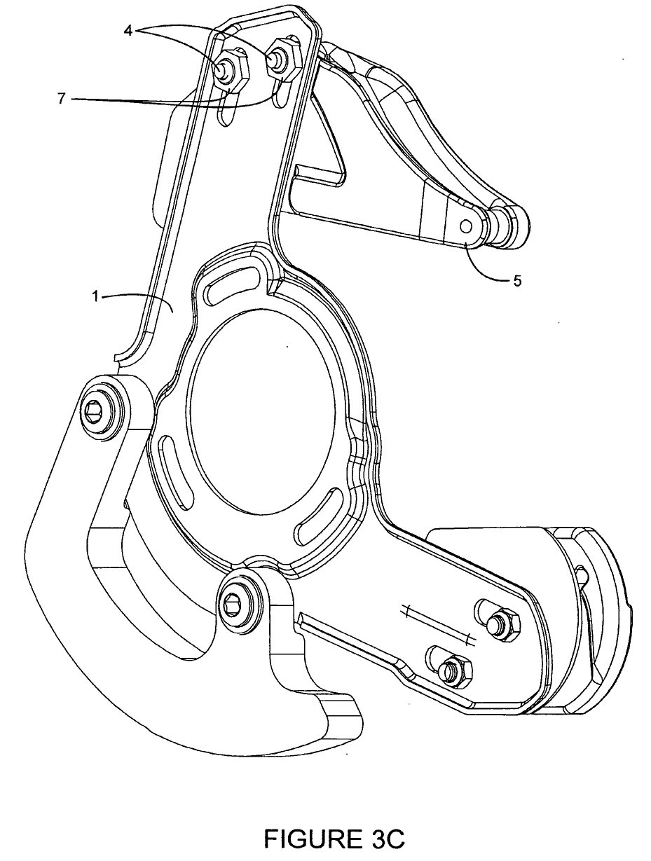

FIG. 3A presents a design for a chainguide according to certain embodiments of the current invention via a back view. Shown in FIG. 3A are the following: mounting plate (1); outer fastener (4); guide element (5); tab fastener (7). A mounting plate 1 supports a tab fastener 7 in at least two degrees of freedom. Material in the mounting plate 1 impedes the tab fastener 7 from passing through the mounting plate 1, while an outer fastener 4 and tab fastener 7 attach a guide element 5 to the mounting plate. The tab fastener 7 and outer fastener 4 are threaded so that when the tab fastener 7 and outer fastener 4 are turned in opposite directions, the tab fastener 7 and outer fastener 4 move towards each other. A clamping force between the tab fastener 7 and outer fastener 4 is developed due to the tab fastener 7 and outer fastener 4 moving towards each other as they are turned in opposite directions. The tab fastener 7 has two or more edges that can be held with a tool or mounting plate 1 feature to impede the rotation of the tab fastener 7, and therefore facilitate the assembly of the outer fastener 4 and tab fastener 7. The tab fastener 7 is designed so that a boss protrudes from the tab fastener 7, towards the mounting plate 1, so that the boss engages with a slot in the mounting plate 1. A slot is manufactured as part of the mounting plate 1. The slot is designed so that the slot has two faces or edges that are in close contact to the boss or previously mentioned faces intended to be held with a tool on the tab fastener 7. The slot is designed such that an tab fastener 7 that is placed in the slot is unable to rotate because faces or edges of the slot meet faces of the tab fastener 7, impeding rotation of the tab fastener 7 due to interference with the slot when the tab fastener 7 begins to rotate. Installation is facilitated by turning the outer fastener 4 while the tab fastener 7 is held from rotating by the interlocking nature of the tab fastener 7 and the slot in the mounting plate 1. Because the tab fastener 7, and slot in the mounting plate 1 interlock and prevent rotation of the tab fastener 7, a secondary tool is not needed to hold the tab fastener 7 during assembly of the chainguide. This has the added benefit of not requiring an assembly technician to try to fit a tool between a bicycle frame and a mounting plate 1 in situations where room to do so may not exist.

FIG. 3B presents a design for a chainguide according to certain embodiments of the current invention via a close up sectional view A-A. Shown in FIG. 3B are the following: mounting plate (1); outer fastener (4); guide element (5); tab fastener (7). A mounting plate 1 supports a tab fastener 7 in at least two degrees of freedom. Material in the mounting plate 1 impedes the tab fastener 7 from passing through the mounting plate 1, while an outer fastener 4 and tab fastener 7 attach a guide element 5 to the mounting plate. The tab fastener 7 and outer fastener 4 are threaded so that when the tab fastener 7 and outer fastener 4 are turned in opposite directions, the tab fastener 7 and outer fastener 4 move towards each other. A clamping force between the tab fastener 7 and outer fastener 4 is developed due to the tab fastener 7 and outer fastener 4 moving towards each other as they are turned in opposite directions. The tab fastener 7 has two or more edges that can be held with a tool or mounting plate 1 feature to impede the rotation of the tab fastener 7, and therefore facilitate the assembly of the outer fastener 4 and tab fastener 7. The tab fastener 7 is designed so that a boss protrudes from the tab fastener 7, towards the mounting plate 1, so that the boss engages with a slot in the mounting plate 1. A slot is manufactured as part of the mounting plate 1. The slot is designed so that the slot has two faces or edges that are in close contact to the boss or previously mentioned faces intended to be held with a tool on the tab fastener 7. The slot is designed such that an tab fastener 7 that is placed in the slot is unable to rotate because faces or edges of the slot meet faces of the tab fastener 7, impeding rotation of the tab fastener 7 due to interference with the slot when the tab fastener 7 begins to rotate. Installation is facilitated by turning the outer fastener 4 while the tab fastener 7 is held from rotating by the interlocking nature of the tab fastener 7 and the slot in the mounting plate 1. Because the tab fastener 7, and slot in the mounting plate 1 interlock and prevent rotation of the tab fastener 7, a secondary tool is not needed to hold the tab fastener 7 during assembly of the chainguide. This has the added benefit of not requiring an assembly technician to try to fit a tool between a bicycle frame and a mounting plate 1 in situations where room to do so may not exist.

FIG. 3C presents a design for a chainguide according to certain embodiments of the current invention via a 3 dimensional back view. Shown in FIG. 3C are the following: mounting plate (1); outer fastener (4); guide element (5); tab fastener (7). A mounting plate 1 supports a tab fastener 7 in at least two degrees of freedom. Material in the mounting plate 1 impedes the tab fastener 7 from passing through the mounting plate 1, while an outer fastener 4 and tab fastener 7 attach a guide element 5 to the mounting plate. The tab fastener 7 and outer fastener 4 are threaded so that when the tab fastener 7 and outer fastener 4 are turned in opposite directions, the tab fastener 7 and outer fastener 4 move towards each other. A clamping force between the tab fastener 7 and outer fastener 4 is developed due to the tab fastener 7 and outer fastener 4 moving towards each other as they are turned in opposite directions. The tab fastener 7 has two or more edges that can be held with a tool or mounting plate 1 feature to impede the rotation of the tab fastener 7, and therefore facilitate the assembly of the outer fastener 4 and tab fastener 7. The tab fastener 7 is designed so that a boss protrudes from the tab fastener 7, towards the mounting plate 1, so that the boss engages with a slot in the mounting plate 1. A slot is manufactured as part of the mounting plate 1. The slot is designed so that the slot has two faces or edges that are in close contact to the boss or previously mentioned faces intended to be held with a tool on the tab fastener 7. The slot is designed such that an tab fastener 7 that is placed in the slot is unable to rotate because faces or edges of the slot meet faces of the tab fastener 7, impeding rotation of the tab fastener 7 due to interference with the slot when the tab fastener 7 begins to rotate. Installation is facilitated by turning the outer fastener 4 while the tab fastener 7 is held from rotating by the interlocking nature of the tab fastener 7 and the slot in the mounting plate 1. Because the tab fastener 7, and slot in the mounting plate 1 interlock and prevent rotation of the tab fastener 7, a secondary tool is not needed to hold the tab fastener 7 during assembly of the chainguide. This has the added benefit of not requiring an assembly technician to try to fit a tool between a bicycle frame and a mounting plate 1 in situations where room to do so may not exist.

### 5.2 MOUNTING PLATES OF CHAINGUIDES OF THE INVENTION

A mounting plate of a chainguide of the current invention, in certain embodiments, comprises a captive fastener feature, slot, guide element, guide element mounting location, guide element mounting slot, guide element mounting hole, mounting stud, flat plate, bent plate, bent edge, stiffening rib, captive fastener, impact protector, impact protector mounting location, mounting location, frame mounting location, and/or a deformable adaptor. A mounting plate of a chainguide of the current invention can be designed to attach to a bicycle frame via a deformable adaptor plate, through a multiple bolted connection to a frame mounting location, or to a bicycle bottom bracket shell using a bottom bracket as a large bolt to secure the mounting plate to the bottom bracket shell. In certain embodiments, a mounting plate supports an inner fastener in at least two degrees of freedom. Material in the mounting plate impedes the inner fastener from passing through the mounting plate, while an outer fastener and inner fastener attach a guide element to the mounting plate. In certain embodiments, a slot is manufactured as part of the mounting plate, where said slot is intended to interlock with an inner fastener in a way that impedes the rotation of the inner fastener. A mounting plate, in certain preferred embodiments can be manufactured by a metal stamping process. A part manufactured by the metal stamping process is referred to as being “stamped”. The metal stamping process in certain embodiments can involve a process or processes including, swaging, coining, bending, bend forming, forming, multiple bend forming, draw forming, deep draw forming, blanking, fine blanking, progressive bending, progressive forming, and/or progressive blanking. The metal stamping process is a process which involves using one or more dies to apply pressure to a sheet of metal to change physical characteristics of the sheet of metal, including the shape, profile, or thickness. A stamped mounting plate, in certain embodiments can be manufactured from steel, steel alloy, aluminum, aluminum alloy, titanium, titanium alloy, magnesium, and/or a magnesium alloy. A captive fastener feature in certain embodiments can be stamped or formed as part of a mounting plate. A mounting plate of a chainguide of the invention is not manufactured from aluminum alloy with a percentage of aluminum in the aluminum alloy greater than 60%, and where CNC machining is used to create mechanical elements used to hold a fastener captive during chainguide and complete bike assembly. A mounting plate of a chainguide of the invention in certain preferred embodiments is manufactured from steel alloy, and where stamping process is used to create a captive fastener feature used to hold a fastener captive during chainguide and complete bike assembly.

### 5.3 INNER FASTENERS OF CHAINGUIDES OF THE INVENTION

An inner fastener of a chainguide of the invention, in certain embodiments, comprises a nut, hex nut, bolt, screw, stud, standoff, spacer, t-nut, tab nut, multi nut, multi fastener, tab fastener, t-bolt, tab bolt, threads, locknut, and/or a locking element. An inner fastener of the invention is designed to be unable to rotate in relation to a mounting plate because faces or edges of the inner fastener interlock with a mounting plate and prevent rotation of the inner fastener when the respective faces or edges are interlocked. Because the inner fastener and mounting plate interlock and prevent rotation of the inner fastener, a secondary tool is not needed to hold the inner fastener during assembly of the chainguide. In certain embodiments an inner fastener is in mechanical contact with a mounting plate either on its own or through an intermediate component. In certain embodiments parts of an inner fastener are located on the side of a mounting plate that is closer to a bicycle frame. In certain embodiments parts of an inner fastener are located on the side of a guide element that is closer to a bicycle frame.

### 5.4 CAPTIVE FASTENER FEATURES OF CHAINGUIDES OF THE INVENTION

A captive fastener feature of a chainguide of the current invention, in certain embodiments, comprises a hole, slot, boss, parallel surfaces, bolt slot, and/or a nut slot. A captive fastener feature is manufactured as part of a mounting plate. The captive fastener feature is designed so that the captive fastener feature has one or more edges that are in close contact to with an inner fastener. The captive fastener feature is designed such that an inner fastener that is placed in proximity to the captive fastener feature is unable to rotate because faces or edges of the captive fastener feature meet faces of the inner fastener, impeding rotation of the inner fastener due to interference with the captive fastener feature when the inner fastener begins to rotate. Installation is facilitated by turning the outer fastener while the inner fastener is held from rotating by the captive fastener feature. Because the inner fastener and captive fastener feature interlock and prevent rotation of the inner fastener, a secondary tool is not needed to hold the inner fastener during assembly of the chainguide. A captive fastener feature, in certain preferred embodiments can be formed in a sheet of metal by a metal stamping process as described herein. A captive fastener feature, in certain embodiments is part of a mounting plate, and can be formed from a metal sheet.

### 5.5 OUTER FASTENERS OF CHAINGUIDES OF THE INVENTION

An outer fastener of a chainguide of the invention, in certain embodiments, comprises a nut, bolt, screw, stud, standoff, spacer, t-nut, tab nut, multi nut, multi fastener, tab fastener, t-bolt, tab bolt, threads, locknut, and/or a locking element. An outer fastener of the invention in certain embodiments is threaded. In certain embodiments, an inner fastener and outer fastener are threaded so that when the inner fastener is held and outer fastener is rotated turned in one direction, the outer fastener moves towards the outer fastener. In certain embodiments, a clamping face of an outer fastener is located perpendicular to the rotation axis and on the side of the outer fastener closer to the inner fastener. A clamping force between the inner fastener and outer fastener is developed due to the inner fastener and outer fastener moving towards each other as they are turned in opposite directions. In certain preferred embodiments, the clamping face of the outer fastener applies pressure to a guide element of a chainguide, and helps to fixedly locate said guide element to a mounting plate in one or more degrees of freedom.

### 5.6 GUIDE ELEMENTS OF CHAINGUIDES OF THE INVENTION

A guide element of a chainguide of the current invention, in certain embodiments, comprises a slider, roller, idler, upper slider, lower slider, upper roller, lower roller, upper idler, and/or a lower idler. A guide element, in certain embodiments, can be part of a mounting plate. A guide element of the invention, in certain embodiments, is designed to be fixed in relation to a chain and a sprocket so that the chain's rollers are guided to engage or disengage with the teeth of a sprocket. A guide element of the invention, in certain embodiments can comprise one or more of the following: a guide element at the point where a chain engages with a sprocket, a guide element at the point where a chain disengages with a sprocket, a guide element or elements for a single sprocket, and/or a guide element for multiple sprockets. A guide element of the current invention in certain embodiments is fixed in relation to a chain and a sprocket via a mounting plate. A guide element of the current invention in certain embodiments is attached to a mounting plate so as to allow adjustment of the guide element in at least one degree of freedom in relation to the mounting plate. A guide element of the current invention in certain embodiments is attached to a mounting plate using a combination of fasteners.

### 5.7 MULTI FASTENERS OF CHAINGUIDES OF THE INVENTION

A multi fastener of a chainguide of the current invention, in certain embodiments, comprises a nut, bolt, screw, stud, standoff, spacer, t-nut, tab nut, multi nut, multi fastener, tab fastener, t-bolt, tab bolt, threads, locknut, and/or a locking element. A multi fastener in certain embodiments has threaded holes for accepting more than one outer fastener. A multi fastener in certain embodiments has holes for accepting and rotationally locating more than one inner fastener. When multiple outer fasteners are engaged with the mounting plate and multi fastener, the outer fasteners interfere with the mounting plate, and through this interference, the rotation of the multi fastener is impeded. This therefore facilitates the assembly of the outer fastener and multi fastener. Because the multi fastener, outer fasteners, and mounting plate interlock in a manner that prevents rotation of the multi fastener, a secondary tool is not needed to hold the inner fastener during assembly of the chainguide.

### 5.8 TAB FASTENERS OF PEDALS OF THE INVENTION

A tab fastener of a chainguide of the current invention, in certain embodiments, comprises a nut, bolt, screw, stud, standoff, spacer, t-nut, tab nut, multi nut, multi fastener, tab fastener, t-bolt, tab bolt, threads, locknut, and/or a locking element. A tab fastener in certain embodiments has threaded holes for accepting one or more outer fastener. In certain embodiments, a tab fastener and outer fastener are threaded so that when the tab fastener and outer fastener are turned in opposite directions, the tab fastener and outer fastener move towards each other. In certain embodiments, a clamping force between the tab fastener and outer fastener is developed due to the tab fastener and outer fastener moving towards each other as they are turned in opposite directions. In certain embodiments, a tab fastener has two or more edges that can be held with a tool or mounting plate 1 feature to impede the rotation of the tab fastener, and therefore facilitate the assembly of the outer fastener and tab fastener. In certain embodiments, a tab fastener is designed so that a boss protrudes from the tab fastener, towards the mounting plate, so that the boss engages with a slot in the mounting plate. In certain embodiments, a washer with a tab interlocks with a mounting plate and an inner fastener so as to impede rotation of the inner fastener.

The present invention is not to be limited in scope by the specific embodiments described herein, which are intended as single illustrations of individual aspects of the invention, and functionally equivalent methods and components are within the scope of the invention. Indeed, various modifications of the invention, in addition to those shown and described herein, will become apparent to those skilled in the art from the foregoing description. Such modifications are intended to fall within the scope of the appended claims. Throughout this application the singular includes the plural and the plural includes the singular, unless indicated otherwise. All cited publications, patents, and patent applications are herein incorporated by reference in their entirety.

What is claimed is:

1. A device for guiding a chain on a bicycle, said device comprising a mounting plate, a guide element, an inner fastener, an outer fastener, a captive fastener feature, wherein said mounting plate is designed from stamped metal, and wherein said captive fastener feature is capable of holding said inner fastener in a fixed position relative to said mounting plate.

2. The device of claim 1, where said stamped metal is not an aluminum alloy with more than 60 percent aluminum.

3. The device of claim 1, where said captive fastener feature impedes rotation of said inner fastener, and where said inner fastener is a multi fastener.

4. The device of claim 1, where said captive fastener feature impedes rotation of said inner fastener, and where said inner fastener is a tab fastener.

5. The device of claim 1, where said captive fastener feature impedes rotation of said inner fastener, and where said inner fastener is a nut.

6. The device of claim 1, where said captive fastener feature impedes rotation of said inner fastener, and where said inner fastener is a hex nut.

7. The device of claim 1, where said captive fastener feature impedes rotation of said inner fastener, and where said inner fastener is a square nut.

8. The device of claim 1, where said captive fastener feature impedes rotation of said inner fastener, and where said inner fastener is a bolt or screw.

9. A device for guiding a chain on a bicycle, said device comprising a mounting plate, a guide element, a multi fastener, an outer fastener, a captive fastener feature, wherein said mounting plate is designed from stamped metal, and wherein said captive fastener feature is capable of holding said multi fastener in a fixed position relative to said mounting plate.

10. The device of claim 9, where said stamped metal is not an aluminum alloy with more than 60 percent aluminum.

11. The device of claim 9, where said captive fastener feature impedes rotation of said multi fastener, and where said multi fastener comprises threads.

12. A device for guiding a chain on a bicycle, said device comprising a mounting plate, a guide element, a tab fastener, an outer fastener, a captive fastener feature, wherein said mounting plate is designed from stamped metal, and wherein said captive fastener feature is capable of holding said tab fastener in a fixed position relative to said mounting plate.

13. The device of claim 12, where said stamped metal is not an aluminum alloy with more than 60 percent aluminum.

14. The device of claim 12, where said captive fastener feature impedes rotation of said tab fastener, and where said tab fastener comprises threads.
